(19) United States
(12) Patent Application Publication
(10) Pub. No.: US 2014/0288236 A1
(43) Pub. Date: Sep. 25, 2014

(54) Silicone Resins Comprising Metallosiloxane

(71) Applicant: Dow Corning Corporation, Midland, MI (US)

(72) Inventors: Michael Depierro, Midland, MI (US); David Pierre, Bxl (Watermael-Boit) (BE); Vincent Rerat, Tubize (BE); Nanguo Liu, Midland, MI (US); Gerald Witucki, Midland, MI (US)

(21) Appl. No.: 14/358,562

(22) PCT Filed: Nov. 14, 2012
(86) PCT No.: PCT/US2012/065010

§ 371 Date: May 15, 2014

Related U.S. Application Data
(60) Provisional application No. 61/560,826, filed on Nov. 17, 2011.

(51) Int. Cl. C08L 83/06; C08L 75/04; C08L 69/00; C08L 23/06; C08L 23/12; C09D 183/06; C08L 67/04; C08L 21/00; C08L 77/06; C08L 67/02; C08L 63/04

(52) U.S. Cl. CPC C08L 83/06; C08L 67/02; C08L 75/04; C08L 69/00; C08L 23/06; C08L 63/04; C09D 183/06; C08L 67/04; C08L 21/00; C08L 77/06; C08L 23/12
USPC 524/588; 525/105; 525/446; 525/453; 525/461; 525/106; 525/476; 525/450

(57) ABSTRACT

The invention relates to silicone resins comprising metallosiloxane which contains for example Si—O-Aluminium bonds. It also relates to their use in thermoplastics, thermosettings organic polymers or any blends of the laters or rubbers or thermoplastic/rubbers blends compositions to reduce the flammability or to enhance scratch and/or abrasion resistance of the organic polymer compositions. It further relates to coatings containing such silicone resins for scratch and/or abrasion resistance enhancement or flame retardant properties.

The invention relates to silicone resins comprising metallosiloxane which contains for example Si—O-Aluminum bonds. It also relates to their use in thermoplastics, thermosettings organic polymers or any blends of the laters or rubbers or thermoplastic/rubbers blends compositions to reduce the flammability or to enhance scratch and/or abrasion resistance of the organic polymer compositions. It further relates to coatings containing such silicone resins for scratch and/or abrasion resistance enhancement or flame retardant properties.

Abrasion typically happens when a surface is rubbed off or worn off by friction whereas scratch is a mark or incision made on a surface by scratching.

Development of efficient halogen-free flame retardant additives for thermoplastics and thermosets is still a great need for many industrial applications. New upcoming regulation such as European harmonized EN45545 norm as well as growing green pressure are pushing the market to develop new effective halogen-free solutions. In the recent years, many researches were made in the field of halogen-free flame retardant. Silicone-based materials are of particular interest in this field.

WO2008/018981 discloses silicone polymers containing boron, aluminum and/or titanium, and having silicon-bonded branched alkoxy groups.

US2009/0227757 describes a modified polyaluminosiloxane obtained by treating a polyaluminosiloxane with a silane coupling agent represented by the formula SiR1R2R3(CH₂)₃X wherein each of R1, R2 and R3 is independently an alkyl group or an alkoxygroup, X is a methacryloxy group, a glycidoxy group, an amino group, a vinyl group or a mercapto group with proviso that at least two of R1, R2 and R3 are alkoxy groups.

U.S. Pat. No. 7,208,536 discloses a polyolefin resin composition comprising a high crystalline polypropylene resin, a rubber component, an inorganic filler and an aluminosiloxane masterbatch, with excellent damage resistance such as anti-scratch characteristic thereby giving very low surface damage, excellent heat resistance, good rigidity and impact properties and injection moldability, for car interior or exterior parts.

US2009/0226609 discloses aluminosiloxanes, titanosiloxanes, and (poly)stannosiloxanes and methods for preparing these.

The abstract of Bryk, M. T.; Anistratenko, G. A.; Il'ina, Z. T.; Natanson, E. M, From Sintez i Fiziko-Khimiya Polimerov (1971), No. 9, 147-50 describes iron-modified polydiphenylsiloxane containing SiOFe groups.

The abstract of Zhdanov, A. A.; Sergienko, N. V.; Trankina, E. S. in Rossiiskii Khimicheskii Zhurnal (2001), 45(4), 44-48 make a review on synthesis of siloxane cages containing such metals as Mn, Ni, Cu, and Na.

GB991284 discloses a process for the manufacture of phosphonated metalloxane-siloxane polymers.

However, even if some of the before mentioned documents describe some Si—O-metal containing polysiloxane, none describe a process for improving the fire resistance or the scratch and/or abrasion resistance of a thermoplastic, thermoset, rubber or thermoplastic/rubber blends matrice polymer composition, characterized in that a silicone resin comprising at least one metallosiloxane which contains Si—O—M bonds whose Metal M is chosen from Ti, Cr, Fe, Co, Ni, Cu, Zn, Sn, Zr or Al Is added to a thermoplastic, thermosetting or rubber or thermoplastic/rubber blends polymer composition. Moreover, this silicone resin can be applied as a coating on different substrate to improve the fire resistance, scratch or abrasion resistance of the latter.

The silicone resin preferably contains T units; D; M′ and/or Q units. The silicone resin preferably contains T units and/or Q units. The resin is characterized by a majority of successive Si—O—M units with the Si selected from R₃SiO_{1/2} (M′ units), R₂SiO_{2/2} (D units), RSiO_{3/2} (T units) and SiO_{4/2} (Q units), and the resin may further contain polyorganosiloxanes, also known as silicones, generally comprise repeating siloxane units selected from R₃SiO_{1/2} (M′ units), R₂SiO_{2/2} (D units), RSiO_{3/2} (T units) and SiO_{4/2} (Q units), in which each R represents an organic group or hydrogen or a hydroxyl group. Branched silicone resins containing T and/or Q units, optionally in combination with M′ and/or D units, are preferred. In the branched silicone resins of the invention, at least 25 mol % of the siloxane units are preferably T and/or Q units. More preferably, at least 75 mol % of the siloxane units in the branched silicone resin are T and/or Q units.

The thermoplastic matrice can be chosen from the carbonate family (e.g. Polycarbonate PC), polyamides (e.g. Polyamide 6 and 6.6), polyester (e.g. polyethyleneterephtalate), polyurethane (PU) etc. The thermoplastic matrice can be chosen from the polyolefin family (e.g. polypropylene PP or polyethylene PE or polyethylene terephtalate PET). The thermoplastic matrice can be a bio-sourced thermoplastic matrice such as polylactic acid (PLA) or polyhydroxybutadiene (PHB) or bio-sourced PP/PE. The matrice can be polybutylene terephtalate (PBT). The matrice can be chosen from thermoplastic/rubbers blends from the family of PC/Acrylonitrile/styrene/butadiene ABS. The matrice can be chosen from rubber made of a diene, preferably natural rubber. The matrice can be chosen from thermoset from the Novolac family (phenol-formol) or epoxy. These above polymers can optionally be reinforced with, for example, glass fibres.

The polymer matrice composition can be an already polymerised composition or a monomer composition wherein the resin is added. In the latter case, the resin can be if needed modified beforehand to become reactive with the monomer composition so as to form a copolymer. For example a Si—O—M resin can be reacted with eugenol to provide terminal —OH bonds. The modified resin can then be reacted with bisphenol-A and phosgene to provide a Si—O—M—PC copolymer.

Preferably, the Si—O—M resin is substantially free from phosphorous atoms.

Preferably, the Metal containing material used to take part to the Si—O—M bonds has the general formula M(R3)m where m=1-7 depending on the oxidation state of the considered Metal, selected from alkoxymetals where R3=OR′ and R′ is an alkyl group, and metal hydroxyl where R3=OH. Metal chlorides where R3=Cl are preferably avoided so as to guarantee that the product of the reaction is halogen free. When M is Al, the alkoxymetal can be for example (Al(OEt)3, Al(OiPr)3, Al(OPr)3, Al(OsecBu)3).

Addition of water during the synthesis is recommended. Water loading are calculated minimum to consume partially the alkoxies and preferably the whole alkoxies present in the system.

Preferably, the whole mixture is refluxed at a temperature preferably ranging from 50 to 160° C. in the presence or not of an organic solvent. Then the alcohol and organic solvent are stripped and possible remaining water are distilled off from the resin through azeotropic mixture.

These new metallosiloxanes may require addition of a condensation catalyst such as protic catalyst or metal based catalyst (e.g. titanate derivatives) to condense. The obtained product can be further dried under vacuum at high temperature (ranging from 50 to 160° C.) to remove remaining traces of solvents, alcohols or water. These resins can be used as additives in polymers or coatings formulations to improve, for example, flame retardancy or scratch and/or abrasion resistance. These new resins can be further blended with various thermoplastic, blends of the later or thermoplastic/rubber blends or rubbers or thermosets to make them flame retardant. These new resins can be further applied as a solution on substrates like steel or wood to form a coating to improve flame retardancy or scratch and/or abrasion resistance.

The invention therefore extends to the use of the silicone resin in a thermoplastic or thermoplastic/rubber blends or rubbers or thermosetting organic polymer matrice composition to reduce the flammability of the organic polymer composition. The invention allows a reduction of the emitted fumes upon burning compared to their non metalized counterparts.

The invention keeps to a certain extent the transparency of the host matrix. In case of the coating approach, it also keeps or improves aesthetic aspect of coated surfaces i.e. the new resin allows to keep the transparency of the polymer it is blended with or the coating made up with the resin is transparent.

The silicone resins of the invention have a high thermal stability which is higher than that of their non-metalized counterparts and higher than that of linear silicone polymers. This higher thermal stability is due to the presence of the metal atoms that leads to the formation of highly stable ceramic structures. Such silicone resins additionally undergo an intumescent charring effect upon intense heating, forming a flame resistant insulating char.

The branched silicone resins of the invention can be blended with a wide range of thermoplastics, any blends of the later, or rubber or thermoplastic/rubbers blends matrices, for example polycarbonates, polyamides, ABS (acrylonitrile butadiene styrene) resins, polycarbonate/ABS blends, polyesters, polystyrene, or polyolefins such as polypropylene or polyethylene. The silicone resins of the invention can also be blended with thermosetting resins, for example epoxy resins of the type used in electronics applications, which are subsequently thermoset, or unsaturated polyester resin. The mixtures of thermoplastics or thermosets with the silicone resins of the invention as additives have been proved to have a low impact on Tg value and thermal stability, as shown by differential scanning calorimetry (DSC) and thermogravimetric analysis (TGA). Subsequently, better flammability properties, as shown by UL-94 test, and/or other flammability tests such as the glow wire test or cone calorimetry, compared to their non metalized counterparts are obtained. The branched silicone resins of the invention are particularly effective in increasing the fire resistance of polycarbonates and blends of polycarbonate with other resins such as polycarbonate/ABS blends.

Applications include but are not limited to transportation vehicles, construction, electrical application, printed circuits boards and textiles for example in polyesters or on coating onto textile. Unsaturated polyester resins, or epoxy are moulded for use in, for example, the nacelle of wind turbine devices. Normally, they are reinforced with glass (or carbon) fibre cloth; however, the use of a flame retardant additive is important for avoiding fire propagation.

The silicone resins of the invention frequently have further advantages including but not limited to transparency, higher impact strength, toughness, increased adhesion between two surfaces, increased surface adhesion, scratch, abrasion resistance and improved tensile and flexural mechanical properties. The resins can be added to polymer compositions to improve mechanical properties such as impact strength, toughness and tensile, flexural mechanical properties and scratch, abrasion resistance. The resins can be used to treat reinforcing fibres used in polymer matrices to improve adhesion at the fibre polymer interface. The resins can be used at the surface of polymer compositions to improve adhesion to paints.

The silicone resins of the invention can for example be present in thermoplastics, any blends of the later, or thermoplastic/rubber blends or rubbers or thermosets polymer compositions or blends of thermoset polymer compositions in amounts ranging from 0.1 or 0.5% by weight up to 50 or 75%. Preferred amounts may range from 0.1 to 25% by weight silicone resin in thermoplastic compositions such as polycarbonates, and from 0.2 to 75% by weight in thermosetting compositions such as epoxy resins. The silicone resin additive can enhance the smoke density of the final composition. Preferably, mechanical performances of the host matrice are maintained or improved. Preferably, transparency retention of host matrice is obtained.

The invention also provides the use of a silicone resin as defined herein above as a fire- or scratch- or abrasion-resistant coating on a substrate. The substrate can be for example PC, glass, steel, wood or wood-like material. The presence of the silicone resin additive can enhance the smoke density of the final composition. Preferably, the coating has good mechanical performances such as flexibility and impact. Preferably, the coated substrate's flame retardancy is improved. Preferably, the coated substrate's scratch- abrasion-resistance is improved. Preferably, the coating is transparent.

The invention further provides a thermoplastic or thermoset organic polymer composition comprising thermoplastics, any blends of the later, or thermoplastic/rubber blends or rubbers or thermosets organic polymer and a silicone resin as defined herein above.

In certain preferred embodiments, the silicone resin disclosed in the present patent can be used in conjunction with another flame retardant compound. Among the halogen-free flame retardants one can find the metal hydroxides, such as magnesium hydroxide (Mg(OH)₂) or aluminium hydroxide (Al(OH)₃), which act by heat absorbance, i.e. endothermic decomposition into the respective oxides and water when heated, however they present low flame retardancy efficiency, low thermal stability and significant deterioration of the physical/chemical properties of the matrices due to high loadings. Other compounds act mostly on the condensed phase, such as expandable graphite, organic phosphorous (e.g. phosphate, phosphonates, phosphine, phosphine oxide, phosphonium compounds, phosphites, etc.), ammonium polyphosphate, polyols, etc. Zinc borate, nanoclays and red phosphorous are other examples of halogen-free flame retardants synergists that can be combined with the silicone material disclosed in this patent. Silicon-containing additives such as silica, aluminosilicate or magnesium silicate (talc) are known to significantly improve the flame retardancy, acting mainly through char stabilization in the condensed phase. Silicone-based additives such as silicone gums are known to significantly improve the flame retardancy, acting mainly through char stabilization in the condensed phase. Sulfur-containing additives, such as potassium diphenyl sulfone sulfonate (known as KSS), are well known flame retardant additives for thermoplastics, in particular for polycarbonate but are only of high efficiency at reducing the dripping effect. In a preferred embodiment, the resin is used in conjunction with Zinc-Borate additive.

Either the halogenated, or the halogen-free compounds can act by themselves, or as synergetic agent together with the compositions claimed in the present patent to render the desired flame retardance performance to many polymer or rubber matrices. For instance, phosphonate, phosphine or phosphine oxide have been referred in the literature as being anti-dripping agents and can be used in synergy with the flame retardant additives disclosed in the present patent. The paper “Flame-retardant and anti-dripping effects of a novel char-forming flame retardant for the treatment of poly(ethylene terephthalate) fabrics” presented by Dai Qi Chen et al. at 2005 Polymer Degradation and Stability describes the application of a phosphonate, namely poly(2-hydroxy propylene spirocyclic pentaerythritol bisphosphonate) to impart flame retardance and dripping resistance to poly(ethylene terephthalate) (PET) fabrics. Benzoguanamine has been applied to PET fabrics to reach anti-dripping performance as reported by Hong-yan Tang et al. at 2010 in “A novel process for preparing anti-dripping polyethylene terephthalate fibres”, Materials & Design. The paper “Novel Flame-Retardant and Anti-dripping Branched Polyesters Prepared via Phosphorus-Containing Ionic Monomer as End-Capping Agent” by Jun-Sheng Wang et al. at 2010 reports on a series of novel branched polyester-based ionomers which were synthesized with trihydroxy ethyl esters of trimethyl-1,3,5-benzentricarboxylate (as branching agent) and sodium salt of 2-hydroxyethyl 3-(phenylphosphinyl)propionate (as end-capping agent) by melt polycondensation. These flame retardant additives dedicated to anti-dripping performance can be used in synergy with the flame retardant additives disclosed in this patent. Additionally, the flame retardant additives disclosed in the present patent have demonstrated synergy with other well-known halogen-free additives, such as Zinc Borates and Metal Hydroxydes (aluminium trihydroxyde or magnesium dihydroxyde) or polyols (pentaerythritol). When used as synergists, classical flame retardants such as Zinc Borates or Metal Hydroxydes (aluminium trihydroxyde or Magnesium dihydroxyde) can be either physically blended or surface pre-treated with the silicon based additives disclosed in this patent prior to compounding.

Therefore, preferably the thermoplastic or thermoset organic polymer composition according to the invention further comprises classical flame retardant additive such as but not limited to inorganic flame retardants such as metal hydrates or zinc borates, magnesium hydroxide, aluminum hydroxide, phosphorus and/or nitrogen containing additives such as ammonium polyphosphate, boron phosphate, carbon based additives such as expandable graphite or carbon nanotubes, nanoclays, red phosphorous, silica, aluminosilicates or magnesium silicate (talc), silicone gum, sulfur based additives such as sulfonate, ammonium sulfamate, potassium diphenyl sulfone sulfonate (KSS) or thiourea derivatives, polyols like pentaerythritol, dipentaerythritol, tripentaerythritol or polyvinylalcohol.

In addition, the resin of the present invention can be used with other additives commonly used as polymer fillers such as but not limited to talc, calcium carbonate. They can be powerful synergists when mixed with the additive described in the present patent.

Examples of mineral fillers or pigments which can be incorporated in the polymer include titanium dioxide, aluminium trihydroxide, magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminium oxide, antimony pentoxide, antimony trioxide, beryllium oxide, chromium oxide, iron oxide, lithopone, boric acid or a borate salt such as zinc borate, barium metaborate or aluminium borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminium flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulfide or wollastonite. Examples of fibres include natural fibres such as wood flour, wood fibres, cotton fibres, cellulosic fibres or agricultural fibres such as wheat straw, hemp, flax, kenaf, kapok, jute, ramie, sisal, henequen, corn fibre or coir, or nut shells or rice hulls, or synthetic fibres such as polyester fibres, aramid fibres, nylon fibres, or glass fibres. Examples of organic fillers include lignin, starch or cellulose and cellulose-containing products, or plastic microspheres of polytetrafluoroethylene or polyethylene. The filler can be a solid organic pigment such as those incorporating azo, indigoid, triphenylmethane, anthraquinone, hydroquinone or xanthine dyes.

### EXAMPLES

### Polyheterosiloxane Material Synthesis Examples

### Example 1

106.6 g tetraethyl orthosilicate (TEOS) was mixed with 108.7 g ethanol and 23.0 g 0.03 M HCl. H2O/Si=2.5. Stirred at RT for 65 hours. This mixture solution was denoted as solution A and used as a stock solution. 11.9 g solution A and 0.91 g Al(O^{S}Bu)3 were mixed at RT. Al/Si=1/7. Aged the mixture 24 hrs at Room Temperature. Drop casted a coating on glass substrate. Formed a clear hard coating after dry at RT for 24 hrs. Then heat treated the coating at 120° C. for 10-20 minutes. Scratch resistance was good.

### Example 2

405 g methyltriethoxysilane was mixed with 200.9 g ethanol, 61.4 g 0.025M HCl and the mixture was stirred at RT for 7 hrs. Added a mixture containing 14.8 g ethyl acetylacetate and 151.6 g Al(O^{S}Bu)3/^{S}BuOH solution (2.5 mmol/g). Al/Si=1/6. The clear solution was stirred at RT for 16 hrs and then added 50 g PGMEA (Propylene glycol methyl ether acetate). Drop-casted the solution on polycarbonate and glass substrates. Formed clear hard coatings after dry at RT for 24 hrs. Then heat treated the coating at 120° C. for 10-20 minutes. Scratch resistance was excellent for both coatings on PC and glass substrates.

### Example 3

19.9 g phenyltrimethoxysilane was mixed with 10 g isopropanol and 10 g toluene in a glass bottle. 4.3 g 0.1 M HCl was added to the above solution and stirred at RT for 30 minutes. Then the prehydrolyzed solution was added slowly to a flask containing 40.0 g Al(O^{S}Bu)₃ (2.5 mmol/g in 2-butanol) and 40 g butylacetate at 90-100° C. After the mixture solution was refluxed for 2 hours Solvents were removed under reduced pressure (0.5 mmHg and 80° C.). A white solid (Al_{0.50}T^{Ph}_{0.50}) was collected.

### Example 4

7.29 g phenylmethyldimethoxysilane, 8.17 g methyltrimethoxysilane, 25 g butylacetate, and 5.08 g 0.05M HCl were mixed in a glass bottle and stirred at RT for 30 minutes. Then the prehydrolyzed solution was added slowly to a flask containing 40.0 g Al(O^{S}Bu)₃ (2.5 mmol/g in 2-butanol), 40 g butylacetate, and 6.5 g ethylacetoacetate at 90-100° C. After the mixture solution was refluxed for 2 hours Solvents were removed under reduced pressure (0.5 mmHg and 80° C.). A white solid (Al_{0.50}D^{PhMe}_{0.20}T^{Me}_{0.30}) was collected.

### Example 5

348.4 g methyltriethoxysilane was mixed with 178.4 g ethanol, 44.0 g 0.025M HCl and the mixture was stirred at RT for 3.5 hrs. Added 85.6 g Al(O^{S}Bu)3/^{S}BuOH solution (2.5 mmol/g). Al/Si=1/10. The solution was stirred at RT for 20 hrs. Drop-casted the solution on polycarbonate and glass substrates. Formed clear hard coatings after dry at RT for 24 hrs. Scratch resistance was good for both coatings on PC and glass substrates.

### Example 6

348.4 g methyltriethoxysilane was mixed with 178.4 g ethanol, 44.0 g 0.025M HCl and the mixture was stirred at RT for 3.5 hrs. Added 85.6 g Al(O^{S}Bu)3/^{S}BuOH solution (2.5 mmol/g). Al/Si=1/10. The solution was stirred at RT for 20 hrs. Drop-casted the solution on polycarbonate and glass substrates. Formed clear hard coatings after dry at RT for 24 hrs. Scratch resistance was good for both coatings on PC and glass substrates.

### Example 7

12.0 g DC 2403 resin (methyl T) was mixed with 12.0 g ethanol, and 1.2 g 0.025 M HCl, stir at RT for 1 hour. Added a solution prepared by mixing 10.6 g Al(O^{S}Bu)3/^{S}BuOH solution (2.5 mmol/g) and 3.8 g ethyl acetylacetate. Stirred at RT for 24 hrs. Drop-casted the solution on polycarbonate and glass substrates. Formed clear hard coatings after dry at RT for 24 hrs. Scratch resistance was good for both coatings on PC and glass substrates.

### Example 8

The procedure was repeated as in Example 4 except that the polyheterosiloxane composition was Al_{0.70}D^{PhMe}_{0.20}T^{Me}_{0.10}.

### Example 9

The procedure was repeated as in Example 4 except that the polyheterosiloxane composition was Al_{0.70}D^{PhMe}_{0.20}T^{Ph}_{0.10}.

### Example 10

The procedure was repeated as in Example 4 except that the polyheterosiloxane composition was Al_{0.50}D^{Me2}_{0.25}T^{Me}_{0.25}.

### Example 11

The procedure was repeated as in Example 4 except that the polyheterosiloxane composition was Al_{0.40}D^{Me2}_{0.30}T^{Me}_{0.30}.

### Preparation of PU Coatings Containing Polyheterosiloxane Additives

Polyurethane coating compositions were prepared by mixing Desmophen A870BA (70% solid, equivalent wt 576) and Desmodur N3390BA (90% solid, equivalent wt 214) at 1/1 equivalent ratio. 0-5% of polyheterosiloxane additives (based on PU solids) were dissolved in butylacetate at around 50% and added to the PU formulation. After complete mixing, the formulation was coated on Al panels using an 8 mil draw-down bar. The coatings sit at RT for 30 minutes and then were heated in an oven for 30 minutes at 110° C. and 30 min at 130° C.

Compatibility of polyheterosiloxane resins with PU composition was believed to play a big role for improved scratch resistance. The concept is that, by carefully designed polyheterosiloxanes, we can manage the micro-segregation of the polyheterosiloxane in PU and migration of the polyheterosiloxane phase into the PU coating surface to enable scratch resistance improvement.

Scratch resistance was tested on a Sutherland Rub Tester using a 2 Kg loading against 3M “0” steel wool. Gloss (60° angle) of the coating was measured before the test and after 45 cycles. The gloss retention is defined as the ratio of Gloss at 45 cycle/Initial Gloss×100%.

### Testing Data

| | Wt % | Gloss |
|---|---|---|
| Polyheterosiloxane compositions | in PU | retention |
| PU control | — | 38% |
| Al_{0.50}T^{Ph}_{0.50} | 0.5% | 53% |
| Al_{0.50}D^{PhMe}_{0.20}T^{Me}_{0.30} | 1% | 50% |
| Al_{0.70}D^{PhMe}_{0.20}T^{Me}_{0.10.} | 0.5% | 60% |
| Al_{0.70}D^{PhMe}_{0.20}T^{Ph}_{0.10.} | 0.5% | 49% |
| Al_{0.50}D^{Me2}_{0.25}T^{Me}_{0.25.} | 2% | 56% |
| Al_{0.40}D^{Me2}_{0.30}T^{Me}_{0.30} | 2% | 65% |
| Al_{0.50}T^{Ph}_{0.50}/Al_{0.50}D^{Me2}_{0.25}T^{Me}_{0.25} = ¼ | 5% | 83% |

1. A process for improving the fire resistance and/or the scratch- or abrasion-resistance of thermoplastics or thermoplastic/rubber blends or rubbers or thermoset organic polymer matrice compositions, wherein a silicone resin comprising at least one metallosiloxane comprises Si—O—M bonds, where Metal M is chosen from Ti, Cr, Fe, Co, Ni, Cu, Zn, Zr, Sn or Al, is added to a thermoplastic, or a thermoplastic/rubbers blend, or a rubber or a thermosetting organic polymer matrice composition.

2. The process according to claim 1 wherein the silicone resin contains T units; D units; M′ units and/or Q units.

3. The process according to claim 1 in which the Metal is aluminum, titanium, tin or any mixture thereof.

4. The process according to claim 1 in which the matrice composition comprises another flame retardant additive.

5. A coating on a substrate, the coating comprising a silicone resin comprising at least one metallosiloxane which comprises Si—O—M bonds where Metal M is chosen from Ti, Cr, Fe, Co, Ni, Cu, Zn, Sn or Al.

6. The process according to claim 1 wherein the matrice composition is the thermoplastic matrice composition and is chosen from carbonates, polyamides, polyesters or polyurethanes.

7. The process according to claim 1 wherein the matrice composition is the thermoplastic matrice composition and is chosen from polyolefins.

8. The process according to claim 1 wherein the matrice composition is the thermoplastic matrice composition and is a bio-sourced thermoplastic matrice composition.

9. The process according to claim 1 wherein the matrice composition is the thermoplastic/rubber blend matrice composition and is chosen from PC/Acrylonitrile/styrene/butadiene ABS rubber blends.

10. The process according to claim 1 wherein the matrice composition is the rubber matrice composition and is natural rubber.

11. The process according to claim 1 wherein the matrice composition is the thermoset matrice composition and is chosen from novolac thermosets or epoxy thermosets.

12. A process according to claim 1 wherein the silicone resin enhances the smoke density of the matrice composition.

13. (canceled)

14. A process according to claim 1 wherein a transparency of the matrice composition is retained after addition of the silicone resin.

15. (canceled)

16. (canceled)

17. The coating according to claim 5 wherein the coating is transparent.

18. (canceled)

19. The process according to claim 6 wherein the thermoplastic matrice composition is the polyamide matrice composition and is chosen from polyamide 6 and polyamide 6.6, or the thermoplastic matrice composition is the polyester matrice composition and is chosen from polyethyleneterephthalate.

20. The process according to claim 7 wherein the thermoplastic matrice composition is the polyolefin matrice composition and is chosen from polypropylene (PP) or polyethylene (PE).

21. The process according to claim 8 wherein the thermoplastic matrice composition is the bio-sourced thermoplastic matrice composition and is chosen from polylactic acid (PLA) or polyhydroxybutadiene (PHB) or bio-sourced PP/PE.
